(19) United States
(12) Patent Application Publication
(10) Pub. No.: US 2008/0190167 A1
(43) Pub. Date: Aug. 14, 2008

(54) Apparatus For Calibrating a Measuring Instrument

(75) Inventor: Gabriele Balboni, Via N. Graziani (IT)

Correspondence Address: YOUNG & THOMPSON, 209 Madison Street, Suite 500, ALEXANDRIA, VA, 22314, US

(73) Assignee: G.V.S.R.L., San Giovanni In Persiceto (Bologna) (IT)

(21) Appl. No.: 11/912,942

(22) PCT Filed: Apr. 26, 2006
(86) PCT No.: PCT/IB2006/001016

§ 371 Date: Dec. 11, 2007

(30) Foreign Application Priority Data
Apr. 28, 2005 (IT) BO2005A000290

(51) Int. Cl. G12B 13/00

(52) U.S. Cl. 73/1.01; 73/1.79

(57) ABSTRACT

An apparatus (10) for calibrating measuring instruments, such as bore gauges and the like, comprises means (12) for supporting the apparatus and calibrating means having contact means for the respective measuring ends (15, 17) of the instrument to be calibrated, these means being, for each measuring end of the instrument to be calibrated, in the form of a first and a second contact surface (31, 33d). The apparatus also comprises at least one adapter element (50) on at least one of the contact surfaces of the calibrating apparatus, this adapter element (50) being designed to receive and support a respective end of the measuring instrument by adjusting to its profile. The adapter element (50) comprises means which engage a respective end of the measuring instrument and which are made in such a way that they can receive different measuring instruments.

### TECHNICAL FIELD

This invention relates to an apparatus for calibrating a measuring instrument.

### BACKGROUND ART

Traditionally, the calibration of instruments for measuring a feature, such as a bore, of a mechanical part is performed manually using a plurality of standard size parts, one for each measurement reading.

Another prior art apparatus for calibrating a measuring instrument comprises a mounting structure and means for calibrating the instrument which, however, must be held firmly in position by operators while it contacts the reference surfaces of the calibrating apparatus.

Under these circumstances, however, calibration tends to be imprecise because it is very difficult for operators to hold the instrument in their hands in exactly the right position for optimum calibration.

For this reason, the trade feels a general need for calibrating means that can be applied to instruments for measuring mechanical features and that permit calibration to be carried out quickly, easily and accurately without having to use a large number of standard forms for all the calibration measurements.

### DISCLOSURE OF THE INVENTION

This invention provides an apparatus to be used for calibrating measuring instruments, such as bore gauges and the like, and comprising means for supporting the apparatus and calibrating means having contact means for the respective measuring ends of the instruments to be calibrated, these means being, for each end of the measuring instrument to be calibrated, in the form of a first and a second contact surface; the apparatus being characterised in that it comprises at least one adapter element on at least one of the contact surfaces of the calibrating apparatus, said adapter element comprising means for engaging a portion of the respective end of the measuring instrument, these engagement means being made in such a way that they can receive different measuring instruments.

This makes it possible to support the instrument to be calibrated in optimum manner so that the calibrations of the measuring instrument are much more accurate than those that would be obtained using the methods known to prior art.

Further, a single adapter element can advantageously be used to hold and calibrate a plurality of measuring instruments of different sizes without having to remove the adapter element.

According to another aspect of it, this invention also provides an apparatus to be used for calibrating measuring instruments, such as bore gauges and the like, and comprising means for supporting the apparatus and calibrating means having contact means for the respective measuring ends of the instruments to be calibrated, these means being, for each end of the measuring instrument to be calibrated, in the form of a first and a second contact surface; the apparatus being characterised in that it comprises means for locking a mobile contact surface in the measuring position.

According to yet another aspect, the invention provides an adapter and a set of adapters that can be used on an apparatus for calibrating measuring instruments.

### BRIEF DESCRIPTION OF THE DRAWINGS

The technical characteristics and advantageous aspects of the invention will become more apparent from the detailed description which follows, with reference to the accompanying drawings which illustrate preferred embodiments of the invention provided merely by way of example without restricting the scope of the inventive concept, and in which:

FIG. 1 is a schematic side view of a preferred embodiment of the apparatus according to the present invention;

FIG. 2 is a perspective view of the contact heads or uprights of adapter elements according to the preferred embodiment of the invention;

FIG. 3 is a view from above showing the parts illustrated in FIG. 2;

FIG. 4 is a front perspective view of a first embodiment of the adapter element according to the present invention;

FIG. 5 is a rear perspective view of the first preferred embodiment of the adapter element according to the present invention;

FIG. 6 is a front view of the first preferred embodiment of the adapter element according to the present invention;

FIG. 7 is a top view of the first preferred embodiment of the adapter element according to the present invention;

FIG. 8 is a cross section through line VIII-VIII in FIG. 6 of the adapter element according to the present invention;

FIG. 9 is a front perspective view of a second embodiment of the adapter element according to the present invention;

FIG. 10 is a rear perspective view of the second preferred embodiment of the adapter elements according to the present invention;

FIG. 11 is a front view of the second preferred embodiment of the adapter element according to the present invention;

FIG. 12 is a top view of the second preferred embodiment of the adapter element according to the invention;

FIG. 13 is a cross section through line XIII-XIII in FIG. 11 of the second preferred embodiment of the adapter element according to the invention;

FIG. 14 is a front perspective view of a third embodiment of the adapter element according to the invention;

FIG. 15 is a rear perspective view of the third preferred embodiment of the adapter element according to the invention;

FIG. 16 is a front view of the third preferred embodiment of the adapter element according to the invention;

FIG. 17 is a top view of the third preferred embodiment of the adapter element according to the invention;

FIG. 18 is a cross section through line XVIII-XVIII in FIG. 16 of the third preferred embodiment of the adapter element according to the invention;

FIG. 19 is a cross section of the apparatus according to the invention, showing the means for locking the mobile head in a first operating condition;

FIG. 20 is a cross section similar to FIG. 19 but showing the means for locking the mobile head in a second operating condition;

FIG. 21 is a longitudinal section of the locking means in a second operating condition, at the mobile head;

FIG. 22 is a schematic side view of the connecting end of the mobile head locking rod;

FIG. 23 shows the other end of the mobile head locking rod;

FIG. 24 is a perspective view of a second embodiment of the apparatus according to the present invention;

FIG. 25 shows the second preferred embodiment of the apparatus according to the present invention in a perspective view from the other side of that of FIG. 24;

FIG. 26 is a side view of the second embodiment of the apparatus according to the invention;

FIG. 27 is a top view of the second embodiment of the apparatus according to the invention;

FIG. 28 is a front view of the fixed head of the second embodiment of the apparatus according to the invention;

FIG. 29 is a top view of a second preferred embodiment of the freely expanding connection which may be used in the second embodiment of the apparatus according to the invention.

### DETAILED DESCRIPTION OF THE PREFERRED EMBODIMENTS OF THE INVENTION

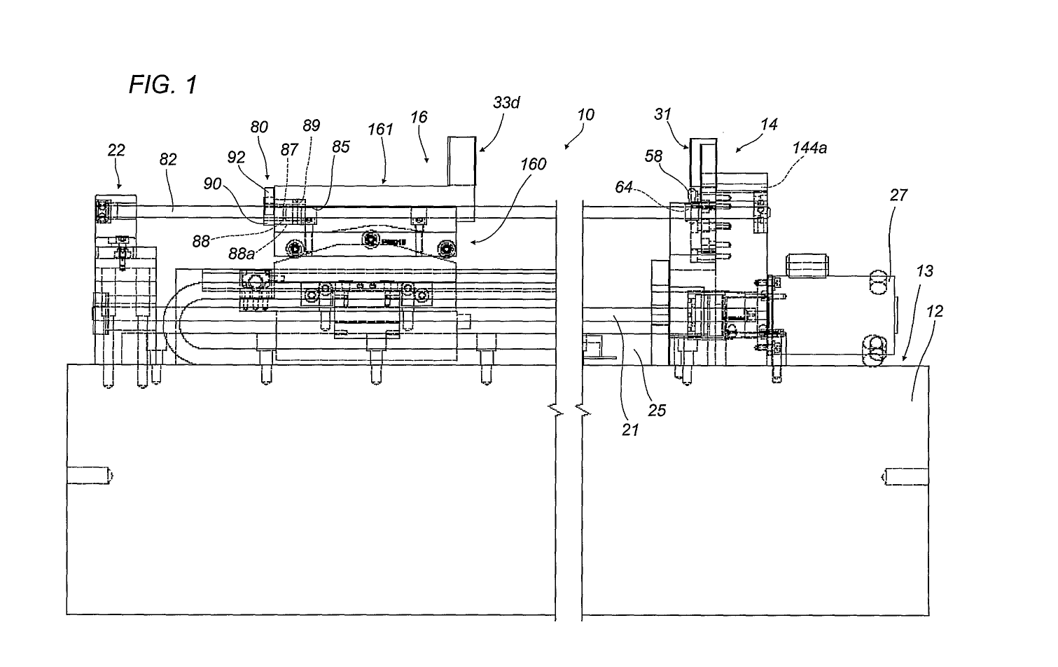

With reference to FIG. 1, an apparatus 10 according to this invention, in a first preferred embodiment of it, is used for calibrating measuring instruments, not illustrated in FIG. 1, such as bore gauges, groove gauges, precision feeler bore gauges, ID and OD micrometers, including stem type micrometers, precision ID and OD caliper gauges, mechanical and electronic contact plug gauges, as described in more detail below. As is known, these measuring instruments have gauging ends that vary considerably according to the type, size and manufacturer of the measuring instrument.

The apparatus according to the invention therefore comprises means for supporting the apparatus, consisting of a frame 13, which in turn comprises a thick base plate 12 made of granite and a cover, not illustrated in detail in the drawing, made from shaped metal sheet and having a long opening from which the contact heads, described in more detail below, extend out of the apparatus. The cover also has a display unit, not illustrated, associated with means for controlling the apparatus, and is substantially the same as that of the apparatus described in international application WO2005/038389 in the name of the same applicant as this invention.

The apparatus according to this invention also comprises means for calibrating measuring instruments.

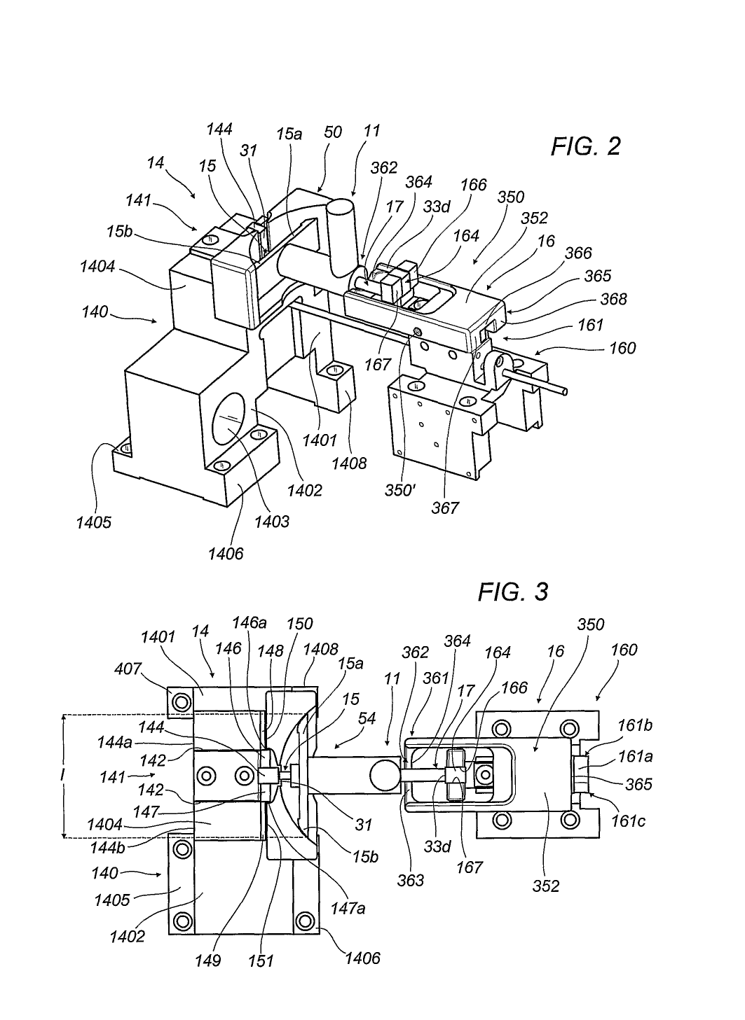

With reference also to FIGS. 2 and 3, the calibrating means comprise means for coming into contact with a first gauging end 15 of the instrument 11 to be calibrated and a second gauging end 17 of the instrument 11 itself. FIGS. 2 and 3 show only the bottom part of the instrument to be calibrated, consisting of a bore gauge.

For example, the measuring instruments may vary in accordance with the width “l” or distance between the ends for supporting a measuring end. As will become more apparent below, the adapter according to the invention is designed to receive instruments having different widths.

The contact means are mobile relative to each other and comprise a fixed block 14 that is engaged by one end 15 of the measuring instrument and has a surface 31—made preferably of ceramic or other suitable material—for coming into contact with that end 15 of the instrument, and a mobile block 16 that also has a contact surface 33d, made preferably of ceramic or other suitable material, for the other end 17 of the measuring instrument.

As illustrated, the contact surfaces 31, 33d are positioned opposite each other. The respective elements that support or define the first contact surfaces 31, 33d support or define, at the respective longitudinally opposite end, corresponding second contact surfaces which are suitable, in particular, for calibrating an instrument used to measure outside diameters. This feature is the same as that of the apparatus described in international patent application WO2005/038389.

As illustrated, the contact surfaces of the fixed block 14 and of the mobile block 16 are aligned with each other along a horizontal line running lengthways along the apparatus, or transversally with respect to an operator standing in front of the apparatus in working condition.

More specifically, as shown in FIGS. 2 and 3, the fixed block 14 comprises a supporting member 140 rigidly fixed to the granite base 12 and a contact element mounting body or block 141 that is fitted in and retained by a long cavity 142 made in the supporting member 140.

As illustrated, the supporting member 140 has a portal frame structure with a first, narrow column 1401 and a second, wider column 1402 having a longitudinal through hole 1403 made in it to house one end of a shaft for driving the mobile head and protruding from a motor 27 mounted on the column 1402.

Looking at it as a whole, with reference to FIG. 2, the fixed block 140 has a stepped shape, with an upright 1404 having a substantially square base, on which there is positioned a mounting block 140 for the contact means.

For strengthening the portal frame structure, each of the columns 1401, 1402, has longitudinal extensions or tabs. More specifically, the longitudinal extensions of the wide column 1402 are labelled 1405 and 1406, whilst the longitudinal extensions of the column 1401 are labelled 1407 and 1408. These extensions have respective holes for respective screws to be inserted into the granite base. This makes the structure of the fixed block particularly rigid and resistant.

The ceramic surface 31 is made at the end of a prismatic insert 144 with a rectangular base held within an opening 145 between two perpendicular walls 146, 147 of the shaped metal mounting block 141. As illustrated, the prismatic insert 144 protrudes from the front and back of the perpendicular walls 146, 147.

At the front of and lower down than the side walls 146, 147 there are plates 148, 149, that are thinner than the side walls 146, 147 and form respective front surfaces 150, 151 for engaging the rear surface of the adapter means.

The side walls 146, 147 also form a longitudinal lateral surface 146a, 147a for guiding or centring the respective surfaces of the adapter.

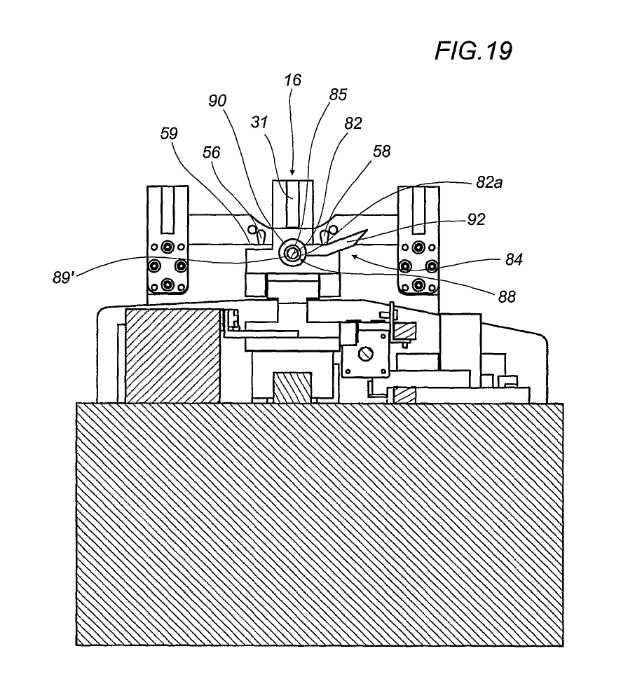

The means for connecting the adapter 50 to the head 14 also comprise, on the head 14, a first and a second pin 56, 58 (better illustrated in FIG. 19) to be inserted into matching holes in the adapter and protruding from a corresponding horizontal flat surface 59 on which the bottom surface of the adapter rests.

Means are also provided for retaining the adapter body, these means being in the form of spring means designed to push the adapter towards and against opposite vertical surfaces 150, 151 of the fixed block 14.

The spring pushing means comprise springs (not illustrated), each supporting a respective insertion pin 56, 58 and being oriented vertically and housed in respective vertical holes made in the fixed block 14, only the hole 64 for the pin 58 being shown in FIG. 1.

At an upper end of the middle upright 144, the fixed block also comprises a first and a second longitudinal through hole—only the hole 144a being illustrated in FIG. 1—which extend horizontally between the rear faces 140b, 140c and the front faces 150′, 151 of the supporting member 140.

These holes for retaining the back of the adapter are designed to receive respective screws (not illustrated) for fastening the back of an adapter in such a way as to provide additional means for locking and securely retaining the adapter in the working position. These locking means are especially advantageous for holding relatively long or protruding adapters. These features are substantially the same as those described in the aforementioned international patent application WO2005/038389.

The mobile block 16 in turn comprises a transversally mobile supporting member 160 and a contact element mounting body or block 161 that is fitted in and retained by a long cavity 162 made in the supporting member 160. Screws are provided to hold the block 161 to the lower mobile guide member 160 and are inserted into matching vertical holes made in a rear, flat top surface of the block 160.

As illustrated in FIGS. 2 and 3, the contact means mounting block 161 extends upwards and comprises a first and a second vertical lateral surface 161b, 161c held between respective opposite first and second longitudinal walls of the supporting member 160.

As illustrated, the ceramic contact surface 33d is made at the end of a prismatic insert 164 with a substantially rectangular base held within an opening between two perpendicular walls 166, 167 of the shaped metal mounting block 161.

Means are also provided for driving the mobile block.

The means for driving the mobile block comprise mobile block guiding means, not illustrated in detail in FIG. 1, comprising a rod of quadrangular cross section extending transversally between the fixed block 14 and an opposite fixed block 22.

More particularly, the second fixed block 22 comprises a supporting member rigidly fixed to the granite base and also having a portal frame structure with a first, narrow column and a second, wider column having a longitudinal through hole made in it for the passage of suitable means for supporting the respective end of the drive shaft, on the side opposite that protruding from the electrical control motor.

The lower end of the mobile block 16 runs on the guide rod, the two parts having matching quadrangular profiles.

The shaft that drives the mobile block 16 backwards and forwards is, advantageously, vertically aligned and parallel with a rod of quadrangular cross section, extending transversally between the fixed block 14 and an opposite fixed block 22 bearing a graduated measuring rod or rule. This arrangement of the drive shaft makes it possible to obtain a particularly accurate calibration.

The mobile block drive means also comprise means for feeding the mobile block itself which in turn comprise a rotary shaft 21, of circular cross section, that is parallel with and longitudinally spaced from the guide rod fixed to the base plate and that also extends transversally between the fixed block 14 and the opposite fixed block 22.

On the rotary shaft 21 there operates an instant locking feed mechanism, housed in the head 16 and not illustrated in detail in the accompanying drawings, which, by rotating the shaft, advances the slider 16, and stops the slider 16 in the desired position to a great degree of precision as soon as the shaft is stopped. Obviously, any other device suited to the purpose might also be used.

The mobile head is driven lengthways along the guide rod 20 by a motor 27 which rotationally drives the shaft 21, said motor being mounted, as illustrated, on the fixed head 14.

The drive shaft 21 is firmly connected to the fixed head 14 by a ring nut acting on a respective bearing in the through hole for the shaft, while, at the opposite end, that is, at the fixed block 22, the shaft 21 is held solely by a bearing housed in a large through hole relative to which it is free to move slightly owing to the expansion of the rod.

There is also provided a tape (not illustrated in the drawings) which closes the opening in the cover when the mobile block moves. The tape 23 is fitted between the fixed heads 14 and 22 and is appropriately connected to the mobile head 16.

Control or processing means are also provided. These means comprise a CPU, a memory unit, a display unit, a keyboard and CPU signal input/output means, none of these being illustrated in the drawings.

Means are also provided for determining the calibration measurement.

The means for determining the calibration measurement comprise means for detecting the position of the mobile block 16, said means comprising a sensor, preferably optical, mounted on the mobile block 16, and a graduated rod 25 supported by the base 12 in front of the means for driving the mobile block 16.

The optical sensor is directed at the graduated rod, or means for determining the calibration measurement, and sends corresponding signals when it passes by the millimetre marks on the graduated rod.

As illustrated, the graduated rod 25, which, for example, might by a rule manufactured by RENISHAW or HEIDENHAI, extends transversally and lies in a vertical plane since it is fixed, firmly on the side facing the block 16. In this way, dirt or other extraneous matter that finds its way into the apparatus does not settle on the rule 25 and cannot upset the measuring operation. These features are substantially the same as those described in the aforementioned international patent application WO2005/038389.

As mentioned above, the apparatus according to the invention also comprises adapting means consisting, more particularly, of an adapter element 50 positioned on the fixed block 14 and enabling a respective measuring instrument 11 to be placed on the device.

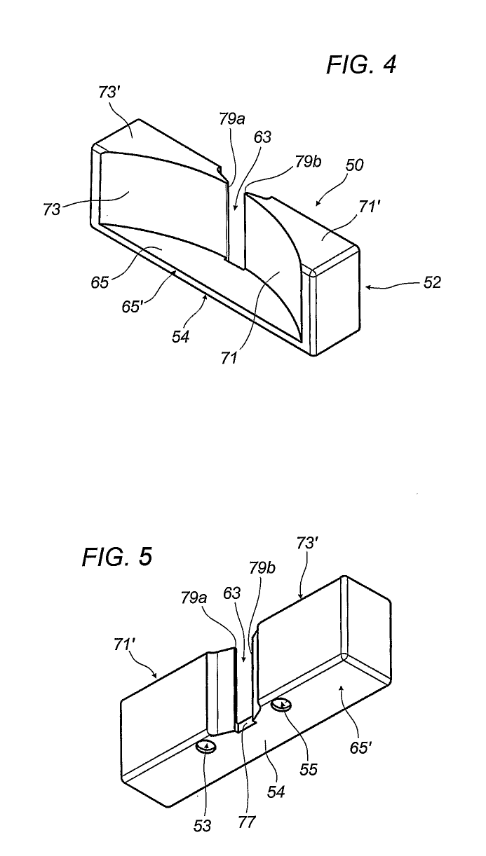

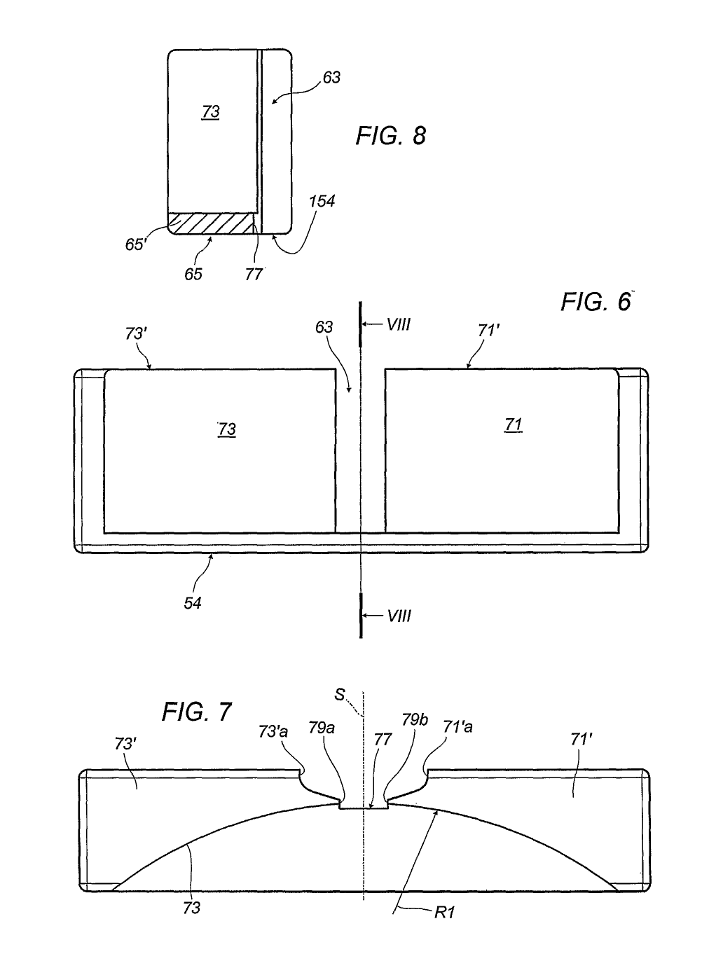

As illustrated in FIGS. 4 to 7, the adapter element according to the invention comprises means which engage a respective end of the measuring instrument and which are made in such a way that they can receive different measuring instruments.

Thus, the engagement means of the adapter element 50 comprise a first and a second lateral engagement surface 71, 73, positioned opposite one another and facing the corresponding portions 15a, 15b of the respective end of the instrument to be supported.

Advantageously, as illustrated, the first and second engagement surfaces 71, 73 of the adapter element 50 are curved surfaces whose curvature radius is such as to define, for each engagement surface, a plurality of contact points for corresponding lateral portions of different measuring instruments.

The curvature radius R1 of these engagement surfaces is preferably 100 mm.

The adapter comprises a slot 63 made in its rear wall and forming a passage for the contact surface 31 of the fixed block 14.

As illustrated, the first and second engagement surfaces 71, 73 extend forward longitudinally from the front edge of the longitudinal surfaces 79b, 79a, forming the respective opening 63, with their concave sections facing the front, that is to say, facing the direction of the instrument to be engaged.

As illustrated, the first and second engagement surfaces 71, 73 extend transversally and symmetrically relative to the sides of the central slot 63.

In practice, as illustrated, considering a virtual axis of symmetry S extending longitudinally from the centre line through the slot 63, the engagement surfaces 71, 73 lie on a single circle whose centre is on the extension of said axis of symmetry S.

Means are also provided for connecting the adapter 50 to the fixed block.

The means for connecting the adapter 50 to the mounting block 14 comprise a first and a second hole 53, 55 made in a horizontal flat bottom surface 54 of the supporting member 52.

As mentioned above, the means for connecting the adapter 50 to the head 14 comprise, on the head 14, a first and a second pin 56, 58 to be inserted into matching holes 53, 55 and protruding from a corresponding horizontal flat surface 57 on which the bottom surface 54 of the adapter rests.

As illustrated, the supporting member 52 comprises respective lateral and vertical abutting surfaces 71 and 73 for opposite side portions 15a, 15b of the shaped end 15 of the measuring instrument 11, each of the lateral surfaces being defined by a first and a second side wall 71′, 73′.

In practice, the bore gauge is placed with the lateral portions 15a, 15b between the surfaces 71 and 73, which form a support in the longitudinal direction and exert a lateral, or transversal, containing action on the gauge.

The adapter 50 also comprises a bottom wall 65′. The latter constitutes both the bottom surface 65 that supports the shaped end 15 of the measuring instrument 11, which, in use, extends horizontally, and the bottom surface 54 that supports the adapter.

The reference numerals 79a and 79b denote longitudinal guide walls for the insertion of opposite lateral faces of the portion 144 which bears the contact surface 31.

The reference numeral 77, on the other hand, denotes a recessed transversal surface for receiving the contact element 31 and which is formed in the bottom wall 65′, while the reference numerals 71′a and 73′a denote respective internal transversal faces of the side walls 71′ and 73′ which converge towards the front of the adapter.

This first preferred adapter 50 is preferably 125 mm wide, measured transversally across the lateral ends of the curved walls 71′ and 73′.

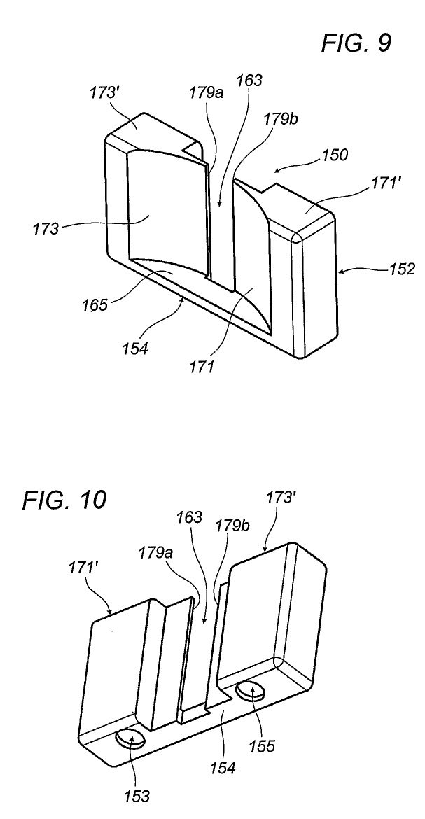

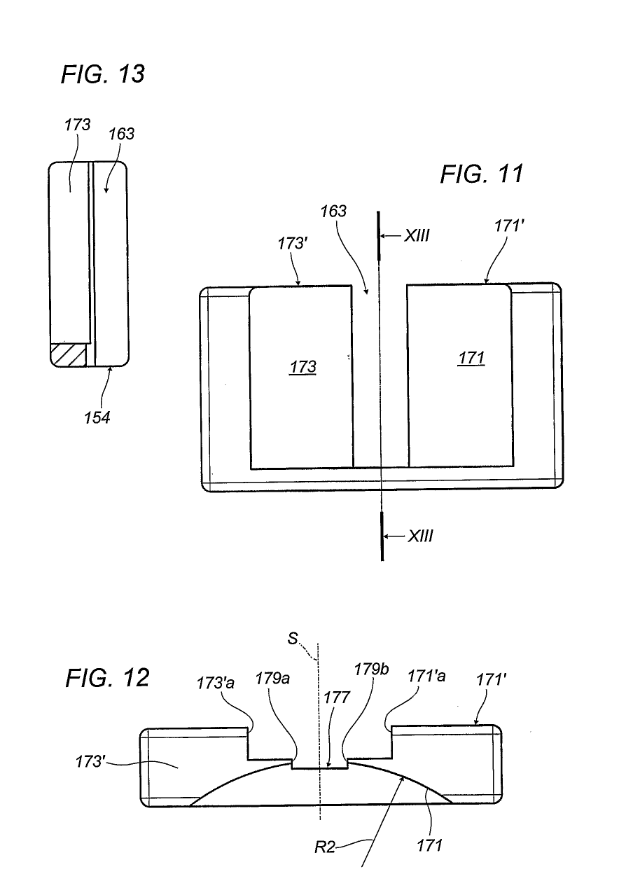

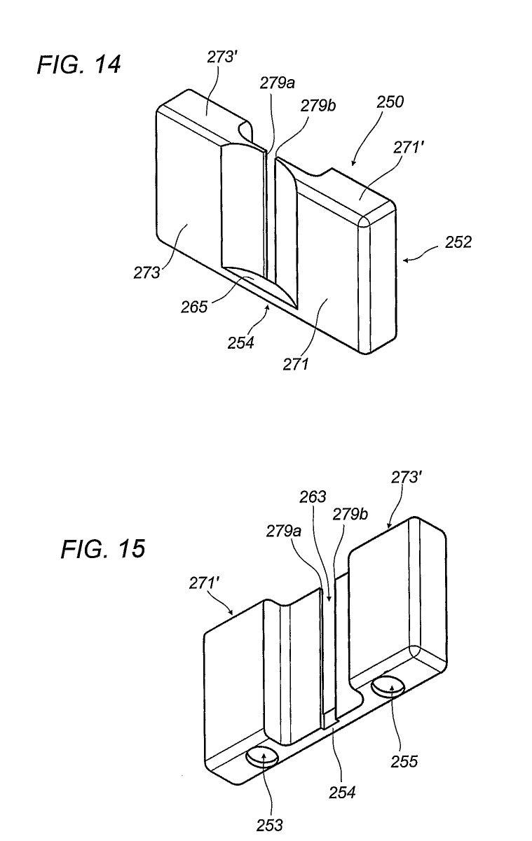

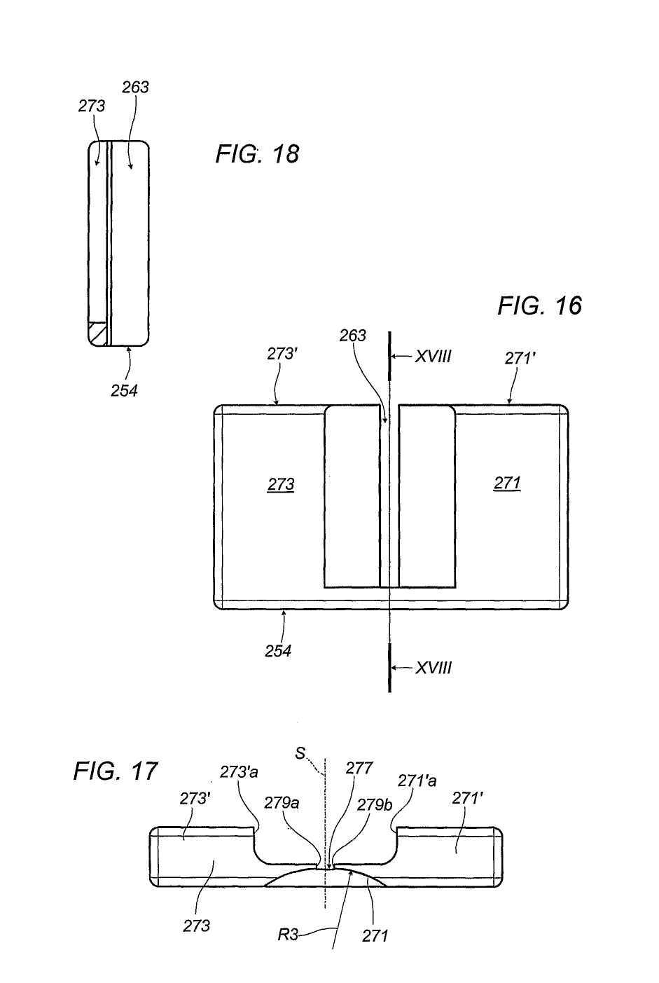

A second and a third embodiment of the adapter element, labelled 150 and 250, respectively, are illustrated in FIGS. 9 to 13 and 14 to 17, respectively. The second and third embodiments 150, 250 of the adapter element are substantially the same as the first preferred embodiment 50, from which they differ mainly in geometrical dimensions, in particular, the different curvature radius of the engagement surfaces which are adapted to support, in similar manner, corresponding pluralities of instruments.

The second and third embodiments 150, 250 of the adapter element comprise engagement means having a first and a second lateral engagement surface 171, 173 and 271, 273, respectively, positioned opposite one another and facing the corresponding portions (15a, 15b) of the respective end of the instrument to be supported.

Advantageously, as illustrated, the first and second engagement surfaces 171, 173 and 271, 273 are curved surfaces whose curvature radius is such as to define, for each engagement surface, a plurality of contact points for corresponding lateral portions of different measuring instruments.

The curvature radius R2, in the second preferred embodiment, is preferably 50 mm, while the curvature radius R3, in the third preferred embodiment, is preferably 25 mm.

Each adapter 150, 250 comprises a central slot 163, 263 made in its rear wall and forming a passage giving the measuring end of the measuring instrument access to the contact surface 31 of the fixed block 14.

As illustrated, the first and second engagement surfaces 171, 173 and 271, 273 extend forward longitudinally from the front edge of the longitudinal surfaces 179b, 179a and 279b, 279a, forming the respective central opening 163, 263, with their concave sections facing the front, that is to say, facing the direction of the instrument to be engaged.

As illustrated, the first and second engagement surfaces 171, 173 and 271, 273 extend transversally and symmetrically relative to the sides of the central slot 163, 263.

In practice, as illustrated, considering a virtual axis of symmetry S extending longitudinally from the centre line through the slot 163, 263, the engagement surfaces 171, 173 and 271, 273, lie on a single circle whose centre is on the extension of said axis of symmetry S.

Means are also provided for connecting the adapter 150, 250 to the fixed block. The means for connecting to the supporting block 14 comprise, a first and a second hole 153, 155 and 253, 255, which are made in a flat, horizontal bottom surface 154, 254 of the respective supporting member 152, 252 and which are designed to receive a matching pin 56, 58 of the fixed head 14.

Each supporting member 152, 252 also comprises respective lateral and vertical abutting surfaces 171, 173 and 271, 273 for opposite side portions 15a, 15b of the shaped end 15 of the measuring instrument 11, each of said lateral surfaces being defined by a first and a second side wall 171′, 173′ and 271′, 273′.

Each adapter 150, 250 also comprises a respective bottom wall 165′, 265′. The latter constitutes the bottom surface 165, 265 that supports the shaped end 15 of the measuring instrument 11, which, in use, extends in a substantially horizontal direction.

The reference numerals 179a, 179b and 279a, 279b denote longitudinal guide walls for the insertion of opposite lateral faces of the portion 144 which bears the contact surface 31.

The reference numeral 177, 277 on the other hand, denotes a recessed transversal surface for receiving the contact element 31 and which is formed in the bottom wall 165′, 265′, while the reference numerals 171′a 173′a and 271′a 273′a denote respective inside faces of the side walls 171′, 173′ and 271′, 273′ constituting surfaces for guiding the element that bears the contact surface.

The maximum width of the second preferred adapter is preferably 80 mm, while the maximum width of the third preferred adapter is preferably 78 mm.

The reference numeral 350 in FIGS. 2 and 3 denotes a second adapter element associated with the mobile head 16.

As illustrated, the adapter element 350 on the mobile head consists of an element 352, preferably of metal, and comprises a vertical plate 361 that defines a triangular or dovetail groove 362 formed by downwardly converging opposite surfaces 363, 364. As illustrated, the groove 362 constitutes a portion for supporting a measuring end 17 of a bore gauge or other measuring instrument and which abuts against the contact surface 33d of the mobile calibrating element 16.

In order to support the plate 361 at the front 33d of the contact means on the mobile head 16, the second element 352 has a C-shaped longitudinal profile 365 having an upper wing 366 abutting against the rear top surface 161a of the contact element mounting block and respective lateral wings 367, 368 placed in parallel over the vertical surfaces 161b, 161c contact element mounting block 161.

The adapter element 350 has engagement means that enable it to be positioned longitudinally in the most suitable position, that is, to be adjusted as required.

For this purpose, the means for locking the second adapter element 352 to the fixed head comprise a suitable threaded pin, not illustrated in FIGS. 2 and 3, which fits into a threaded hole 350′ and whose front end is designed to contact the corresponding lateral surface 161b of the contact element mounting block. The pin is actuated by a knob that is not illustrated in the drawings. By screwing the locking pin in and out, the adapter 350 can be moved backwards and forwards on the mobile head 16, to the required position suitable for supporting a corresponding end of the adapter. At this point, all that needs to be done is to turn the actuating knob in order to stop the pin against the corresponding surface 161b, thereby causing the locking pin to lock the adapter 350 with respect to the mobile head 16.

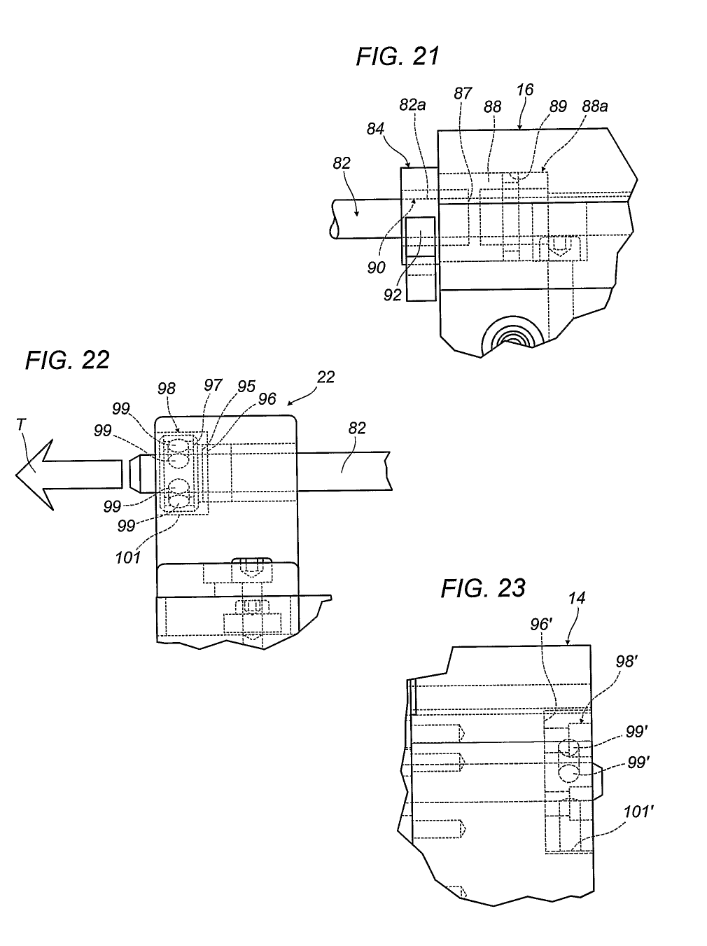

According to another aspect, illustrated in particular in FIG. 1 and in FIGS. 19 to 21, the calibrating apparatus according to the invention also comprises means 80 for locking the mobile contact element 31 in the measuring position.

As illustrated in FIG. 1, these locking means 80 comprise a rod 82 which extends across the fixed heads 14 and 22 and to which the mobile head 16 is suitably connected, as described in more detail below.

In practice, the rod 82 extends longitudinally along the apparatus and passes through a hole 85 in the mobile head 16 and through a hole 87 in a bush 88 fitted in a matching cylindrical opening 89 made at the end of the mobile head 16 opposite the end facing the main fixed head 14.

For locking the mobile head 16 in place when a measuring instrument is calibrated, suitable retaining means 84 which can be engaged and released manually are provided, said means 84 acting in conjunction with the rod 82 to lock the mobile head 16 in the measuring position.

These retaining means 84 can be moved between a position in which the mobile head 16 can slide freely with respect to the fixed rod 82 and a position in which the mobile head 16 is locked to the fixed rod 82.

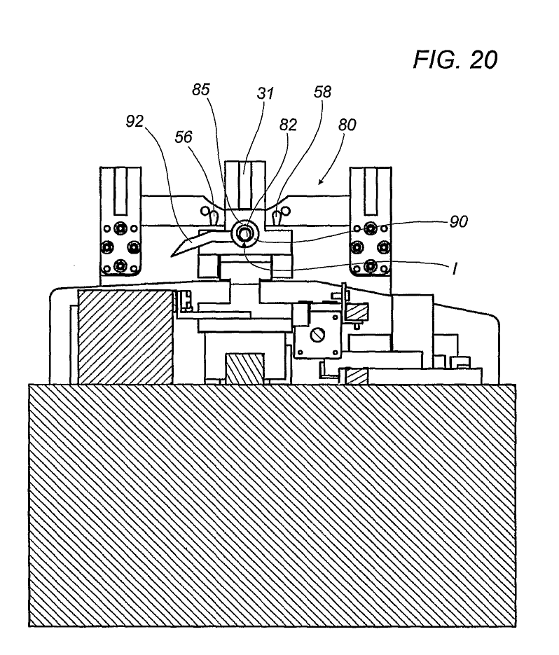

In practice, the annular element 88 of the retaining means 84 can turn freely in the hole or housing opening 89 between an angular position, illustrated in FIG. 19, in which the mobile head 16 can move freely, and an angular position, illustrated in FIG. 20, in which it is locked to and cannot slide along the rod on the fixed head.

As illustrated in particular in FIGS. 19 and 20, the bush 88 has, on the outside of the opening 89 in the mobile head 16, an annular portion 90 from which there extends a protruding portion 92 defining an actuating lever.

In practice, in the free sliding position illustrated in FIG. 19, there is annular gap, labelled 89′, between the inside surface of the hole 85 in the annular retaining element 88 and the outside surface 82a of the locking shaft 32, preventing the two parts from coming into contact and thus allowing the mobile head to slide freely relative to the rod 82.

When the actuating lever 92 is turned from the sliding position shown in FIG. 19 to the locked position shown in FIG. 20, thanks to the fact that the hole 85 through which the rod 82 passes is eccentrically positioned relative to the outside cylindrical surface 88a of the fixed rod 82, interference is created between said outside cylindrical surface 82a and the inside surface 85 of the annular element 88, in particular at the point “I” shown in FIG. 20.

Advantageous means are also provided for tensioning the locking rod 82. These tensioning means make it possible to avoid dangerous bending of the locking rod 82.

In particular, the tensioning means comprise means for applying a pulling action “T” on the rod 82, as shown in FIG. 22.

As illustrated in FIG. 22, these tensioning means consist of spring means, schematically illustrated and labelled 95 in the drawing, which act between a shoulder surface 96 in the fixed head 22 and a corresponding transversal surface element 97 located on an annular element 98 attached to the corresponding end of the fixed rod 82.

The element 98 attached to the fixed rod 82 comprises a plurality of spherical elements, labelled 99 in the drawing, which are peripherally positioned around the corresponding outside surface of the rod 82 and pushed against said surface in such a way as to firmly engage the rod 82.

These engagement elements 99 are mounted in an annular frame 98 housed in a respective cavity 101 formed in the side of the head 22 opposite the other fixed head 14.

At the other fixed head 14, the tensioning means also comprise, as illustrated in FIG. 23, respective means for retaining the rod 82, which in turn comprise respective engagement spheres 99′, circumferentially positioned around the corresponding peripheral surface of the rod 82. The retaining elements 99′ are housed in an annular element 98′ which abuts against a corresponding surface 96′ of a cavity 101′ formed in the side of the head 14 opposite the mobile head 16.

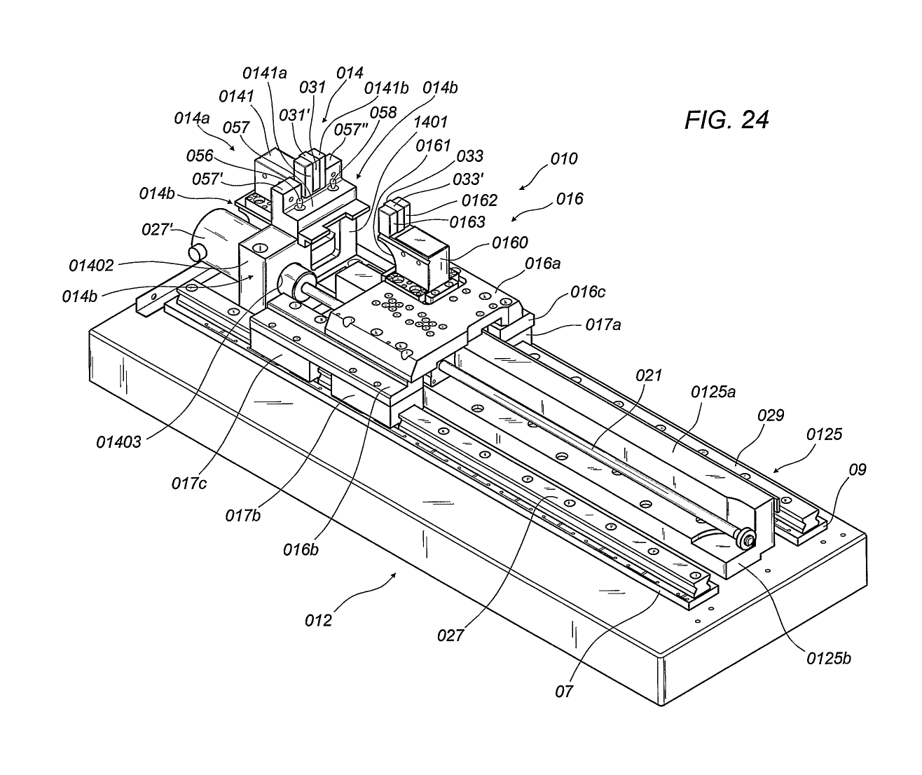

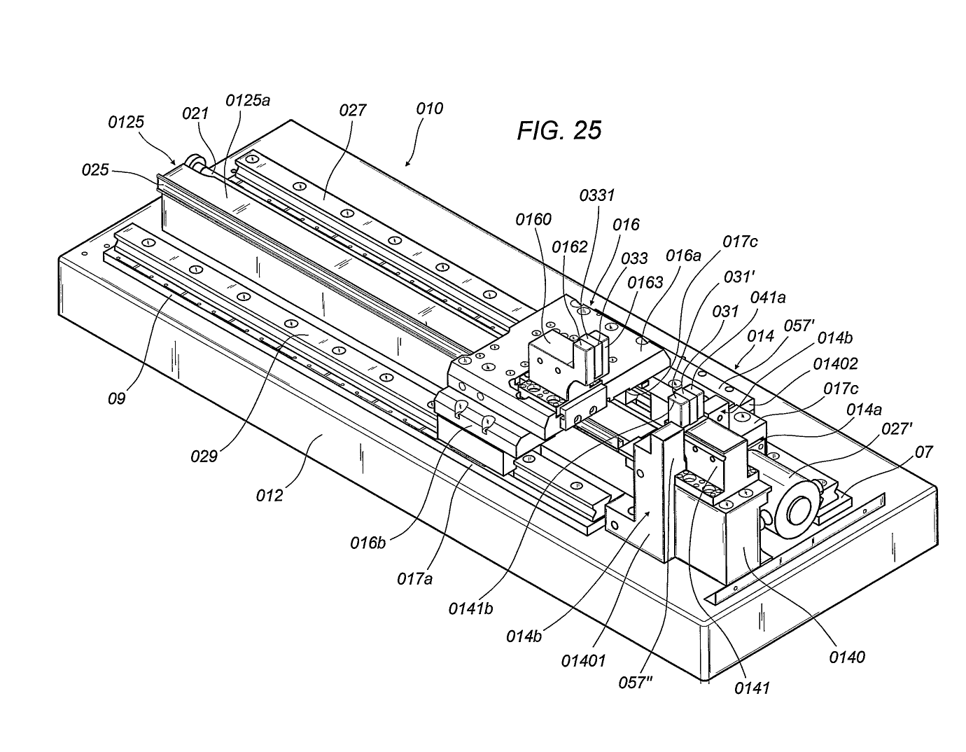

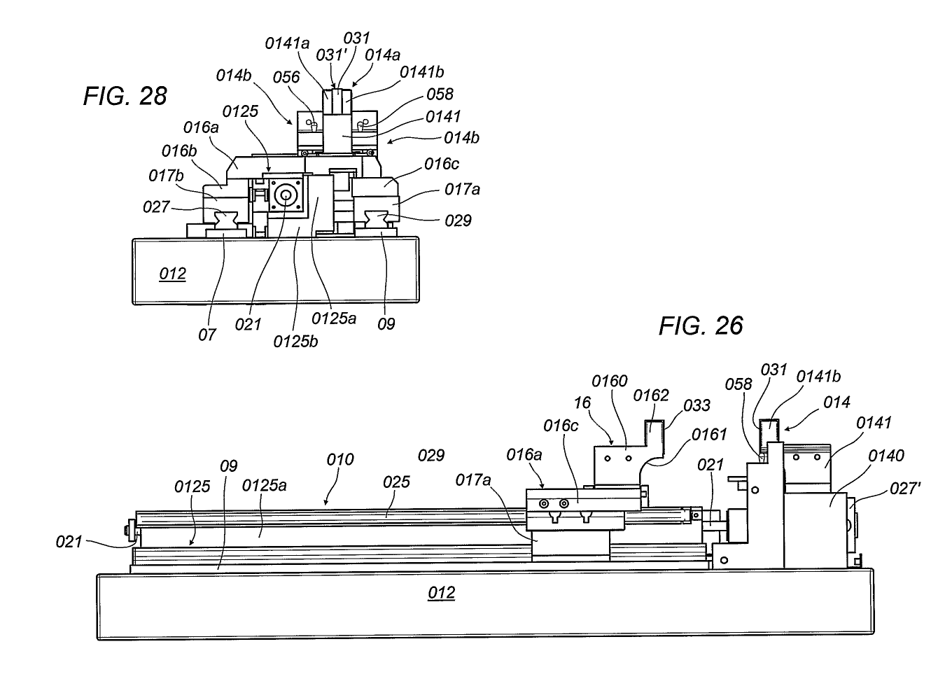

A second preferred embodiment 010 of the apparatus for calibrating a measuring instrument is illustrated in FIGS. 24 to 28.

This embodiment of the apparatus according to the invention comprises means for supporting the apparatus consisting of a thick base plate 012 preferably made of granite and a cover, not illustrated in detail in the drawing, made from shaped metal sheet and having a long opening from which the contact heads extend out of the apparatus, as in the first embodiment, described above. The cover also has a display unit, not illustrated, associated with means for controlling the apparatus.

The second embodiment of the apparatus according to this invention also comprises means for calibrating measuring instruments.

As may be inferred from the drawings, the calibrating means comprise corresponding contact means including a fixed block 014, that is engaged by one end of the measuring instrument and has a surface 031—of ceramic or other material—which comes into contact with the end of the instrument, and a mobile block 016, that also has a surface 033—of ceramic or other material—which comes into contact with the corresponding end of the measuring instrument.

As illustrated, the contact surfaces 031, 033 are positioned opposite each other. The respective supporting elements support, or define, at the respective longitudinally opposite end, corresponding second contact surfaces which are suitable, in particular, for calibrating an instrument used to measure outside diameters.

As illustrated, the contact surfaces of the fixed block 014 and of the mobile block 016 are aligned with each other along a horizontal line running lengthways along the apparatus, or transversally with respect to an operator standing in front of the apparatus in working condition.

The means that drive the mobile block 016 backwards and forwards comprise a revolving shaft 021 that extends longitudinally between the fixed block 014 and the opposite fixed block, not illustrated in the drawings, in exactly the same way as in the first preferred embodiment.

As in the first preferred embodiment, described above, the revolving shaft 21 of the second embodiment is operated upon by an instant locking feed mechanism, housed in the head 016 and not illustrated in detail in the accompanying drawings, which, by rotating the shaft, advances the slider 016, and stops the slider 016 in the desired position to a great degree of precision as soon as the shaft is stopped.

The mobile head is driven lengthways along the guide rod 020 by a motor 027′ which rotationally drives the shaft 021, said motor 027′ being mounted, as illustrated, on the fixed head 014.

Control or processing means are also provided. These means comprise a CPU, a memory unit, a display unit, a keyboard and CPU signal input/output means, none of these being illustrated in the drawings.

Means are also provided for determining the calibration measurement of the respective instrument. The means for determining the calibration measurement comprise means for detecting the position of the mobile block 016, said means comprising a sensor, preferably optical, mounted on the mobile block 016, and a graduated rod 025 extending parallel to and on one side of the means 021 for driving the mobile block 016. The optical sensor is directed at the graduated measuring rod and sends corresponding signals when it passes by the millimetre marks on the graduated rod 025.

As illustrated, the graduated rod 025 extends in a vertical plane.

The apparatus according to the invention also comprises adapting means consisting, more particularly, of an adapter element like the ones described above, said adapter element being positioned on the fixed block 014 and enabling a respective measuring instrument to be placed on the device. The adapter element is not illustrated in detail in FIGS. 24 to 29, which do, however, clearly show the first and second adapter retaining pins 056, 058 that are designed to be inserted into respective holes in the adapter and protrude from a corresponding flat horizontal surface of a crosspiece 057 on which the underside of the adapter rests.

Means 027, 029 are also provided for guiding the mobile block 016 and which advantageously comprise a first and a second guide rod 027, 029 extending lengthways and being transversally spaced from each other. The first and second guide rods enable the mobile block 016 to be moved in a more balanced manner, thus achieving improved measuring precision.

As illustrated, the mobile block 016 has a large transversal plate 016a which extends transversally across the first and second guide rods 027, 029 and which is mounted on side shoes 017a, 017b, 017c running on the respective guides 027, 029 through side connecting blocks 016b, 016c.

Advantageously, there extends upwards from a lateral or offset position on this large quadrangular plate 016a an element 0160 for supporting the block 033′ and defining the contact surfaces of the mobile block 016, said block 033′ being held between the vertical fork-like branches 0162, 0163 of the supporting element 0160.

Advantageously, the contact surface supporting element 0160 has a curved bottom section 0161 joining the main body of the block 0160 to the fork 0162, 0163 that holds the element 033′ and defines the contact surfaces. This guarantees greater overall strength and, hence, higher measuring precision.

As illustrated, the drive shaft 021 extends between the guide rods 027, 029. Thus, the pulling action applied to the mobile block in order to move it is more balanced, without unwanted torsion on the mobile block itself and guaranteeing higher measuring precision.

Further, as illustrated, the mobile block 016 has, on one side, a first slide shoe 017a and, on the opposite side, a first and a second slide shoe 017b, 017c, aligned with each other lengthways.

As illustrated, the distance between the drive shaft 025 and the guide rod 027 for the pair of shoes 017b, 017c is one third of the distance between the guide rods 027, 029, and, therefore, the distance between it and the guide rod for the single shoe 017a is two thirds of the distance between the guide rods. This allows a more uniform distribution of the sliding stress transmitted by the drive shaft to the shoes, which in turn means higher measuring precision.

Advantageously, the invention contemplates the provision of freely expanding means 07, 09 for connecting the guide means 027, 029 to the base 012 in order to prevent stress due to different thermal expansion of the base and guides.

More specifically, the freely expanding means for connecting the guide means to the base comprise interposed means 07, 09 located between the guide means 027, 029 and the base 012.

With reference also to FIG. 29, which shows a second embodiment 07′ of these interposed elements, the freely expanding means for connecting the guide means to the base comprise means 06 for fastening them to the base and means 08 for fastening them to the guide means, the means 08 for fastening them to the guide means being connected to the means for fastening them to the base in such a way as to allow free expansion or movement in the direction of extension of the guide means 027, 029.

The freely expanding means for connecting the guide means to the base comprise a respective elongated rod 07′ which, as may be easily inferred from the second embodiment shown in FIG. 29, has a main fastening body 05 and a set of fastening blocks 03, the latter being aligned with each other and distributed lengthways along the main body 05.

As shown in FIG. 29, each block 03 is connected to the main body 05 in such a way that it can move lengthways relative to the main body 05.

As illustrated, each block 03 has a quadrangular shape and is connected to the main body 05 through a transversal portion 03a which is designed to bend lengthways relative to the body 05 and projects from a lateral edge of the block 03 itself.

Each block 03 is also connected to the main body 05 through a second portion 03b which can also bend lengthways relative to the main body and projects from the lateral edge of the block 03 on the side opposite the first bending portion 03a.

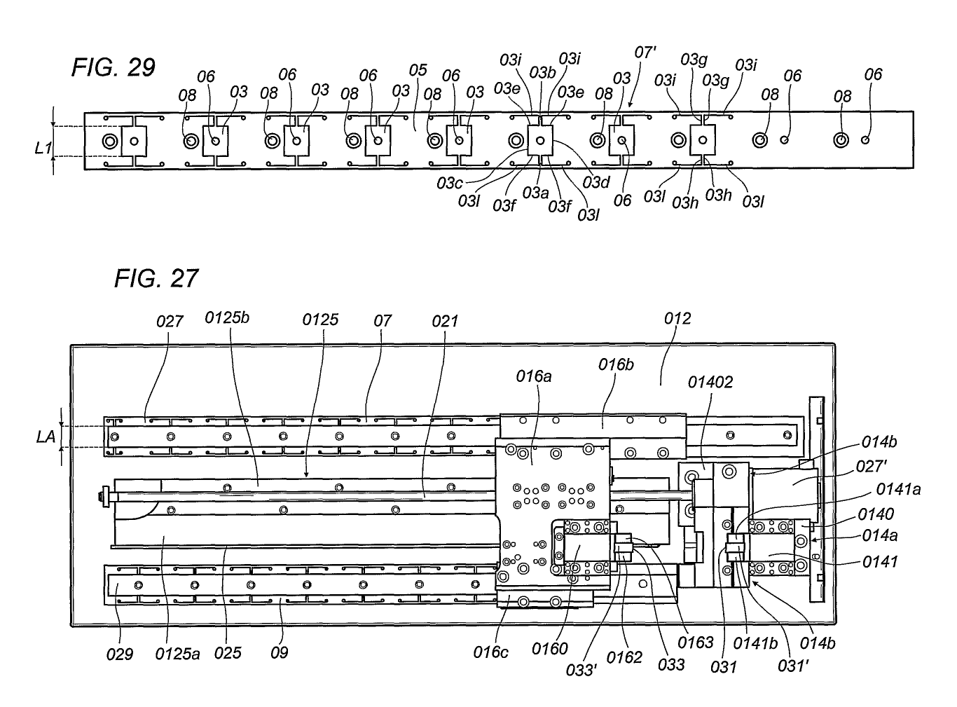

In this second preferred embodiment, each block 03 has a width LT that is greater than the width LA of the respective guide rod (illustrated in FIG. 27). This means that the guide rests securely on the block and not on the parts of the body 05 on each side of it.

The block 03 is defined by a first and a second transversal end slot 03c, 03d from which there extend lengthways respective first and second side slots 03e, 03f, in the direction of the other transversal end slot 03c, 03d of the block 03 itself.

As illustrated, from the corresponding longitudinal slots 03e, 03f, there extend, towards the outer edges of the body 05, respective transversal slots 03g, 03h, from which there extend in turn, in opposite longitudinal directions, respective slots 03i, 03i and 031, 031.

These longitudinal slots 03i, 03i and 031, 031 extend in opposite directions past the respective transversal end slots 03c and 03d in the block, as illustrated in FIG. 29.

The slots defining each block 03 are made by laser cutting a metal rod having a C-shaped cross section.

The means 06 for fastening to the base and the means 08 for fastening to the guide means consist of holes 06, 08 for respective screws which are not illustrated in the accompanying drawings. Preferably, as illustrated, the holes 08 for fastening the freely expanding element 07′ to the base are made in the main body 05, while the holes 06 for fastening the guide means to the freely expanding element 07′ are made in the blocks 03. A reversed position for these holes is also possible, however.

As shown in FIG. 29, a pair of holes 06, 06 for fastening the respective guide and a pair of holes 08, 08 for fastening to the base are made directly in the main body 05 of the interposed metal rod 07′ so as to fasten it more securely, especially at the fixed head.

This embodiment has a graduated measuring rod 025 which is advantageously raised with respect to the base 012, extending above the guide means 027, 029 to a position just below the transversal element 016a of the mobile block 016.

This further reduces measuring errors due to longitudinal bending of the mobile block 016 and increases measurement accuracy and precision.

Advantageously, the graduated measuring rod 025 is mounted on an essentially L-shaped supporting element 0125, with a branch 0125a that extends upwards and supports the graduated measuring rod 025 on a respective vertical face at or near the top end of the supporting element 0125 itself.

The supporting element 0125 also has a horizontal portion 0125b which rests on the base 012 and over which the drive shaft 021 extends.

Further, in this second preferred embodiment of the apparatus, the adapter element is fastened to a fixed supporting block 014b, while the contact surface is fastened to a respective fixed supporting block 014a that is separate from the block 014a that supports the adapter element.

Thus, when the measuring instrument is placed against the adapter in the same way as in the first preferred embodiment, the stress exerted by the application of the instrument to the engagement surfaces of the adapter is transmitted to the respective supporting block 014b and not on the supporting block 014a of the contact surface. This prevents unwanted bending of the block 014a that supports the contact surface 031, thus improving measuring precision.

More specifically, as shown in FIGS. 24 to 28, the fixed block 014a comprises a column-like base 0140 which is rigidly fixed to the granite base 012 and which supports at the top a contact element 031′ mounting body or block 0141 that defines the contact surface 031.

The adapter mounting block 014b, too, also rigidly fixed to the base 012, has a portal frame structure with a first, narrow column 01401 and a second, wider column 01402 having a longitudinal through hole 01403 made in it for the passage of a motor drive shaft supported by the column 01402 itself.

The adapter mounting block 014b supports the first and second pins 056, 058 that are designed to be inserted into respective holes in the adapter and protrude from a corresponding flat horizontal surface of a crosspiece 057 on which the underside of the adapter rests.

The crosspiece 057 connects the columns 01402 and 01401 of the block 014b and has a pair of uprights 057′ and 057″ with a transversal gap between them for the insertion of the block 0141 which mounts the contact surface element 031′ supported by the fork portions 0141a and 0141b.

As illustrated, the base 0140 for the contact surface mounting block 0141 extends behind the adapter mounting body 014b.

The invention described can be modified and adapted in several ways without thereby departing from the scope of the inventive concept. Moreover, all the details of the invention may be substituted by technically equivalent elements.

1-62. (canceled)

63. An apparatus for calibrating measuring instruments, such as bore gauges and the like, and comprising means for supporting the apparatus and calibrating means having contact means for the respective measuring ends of the instruments to be calibrated, and consisting, for each end of the measuring instrument to be calibrated, of a first and a second contact surface; wherein it comprises at least one adapter element on at least one of the contact surfaces of the calibrating apparatus, said adapter element comprising means for engaging a corresponding portion of the respective end of the measuring instrument, and comprising engagement means having first and second engagement surfaces positioned opposite to each other; and being in the form of curved surfaces that can receive different measuring instruments.

64. The apparatus according to claim 63, wherein the curvature radius of the engagement surface varies preferably between 25 mm and 100 mm.

65. The apparatus according to claim 63, wherein the adapter element comprises a slot which forms a passage for a contact surface of the apparatus.

66. The apparatus according to claim 63, wherein the adapter element comprises a bottom supporting surface for the shaped end of the measuring instrument.

67. An apparatus for calibrating measuring instruments, such as bore gauges and the like, and comprising means for supporting the apparatus and calibrating means having contact means for the respective measuring ends of the instruments to be calibrated, and consisting, for each end of the measuring instrument to be calibrated, of a first and a second contact surface; wherein it comprises at least one adapter element on at least one of the contact surfaces of the calibrating apparatus, said adapter element comprising means for engaging a corresponding portion of the respective end of the measuring instrument, wherein said adapter element comprising engagement means that can be positioned lengthways in suitable longitudinal positions for engaging the respective end of the instrument to be calibrated.

68. The apparatus according to claim 67, wherein the adapter element comprises engagement means having a first and a second surface positioned opposite to and converging on one another and being designed to engage respective parts of the end of the measuring instrument.

69. An apparatus for calibrating measuring instruments, such as bore gauges and the like, and comprising means for supporting the apparatus and calibrating means having contact means for the respective measuring ends of the instruments to be calibrated, and consisting, for each end of the measuring instrument to be calibrated, of a first and a second contact surface; wherein it comprises at least one adapter element on at least one of the contact surfaces of the calibrating apparatus, said adapter element comprising means for engaging a corresponding portion of the respective end of the measuring instrument, wherein the contact means comprise a mobile block that supports an end of the measuring instrument.

70. The apparatus according to claim 69, wherein it comprises means for locking a mobile contact surface block in the measuring position.

71. The apparatus according to claim 70, wherein the locking means comprise a locking rod and retaining means which can be engaged and released and which act in conjunction with the rod.

72. The apparatus according to claim 71, wherein the retaining means comprise an annular element having an inside surface through which the locking rod passes.

73. The apparatus according to claim 72, wherein the annular element has an inside hole which, in the locking position, interferes with the outside surface of the locking rod.

74. The apparatus according to claim 73, wherein the engageable/releasable retaining means that act in conjunction with the rod comprise an annular element having an outside surface that is freely and rotatably housed in a matching surface of the mobile head.

75. An apparatus for calibrating measuring instruments, such as bore gauges and the like, and comprising means for supporting the apparatus and calibrating means having contact means for the respective measuring ends of the instruments to be calibrated, and consisting, for each end of the measuring instrument to be calibrated, of a first and a second contact surface; wherein it comprises at least one adapter element on at least one of the contact surfaces of the calibrating apparatus, said adapter element comprising means for engaging a corresponding portion of the respective end of the measuring instrument, wherein it comprises means for tensioning the rod that locks the mobile head in the measuring position.

76. The apparatus according to claim 75, wherein the tensioning means comprise spring means.

77. The apparatus according to claim 76, wherein the spring means act between a shoulder surface in the fixed head and a corresponding annular element attached to the corresponding end of the fixed rod.

78. The apparatus according to claim 69, wherein it comprises means for guiding the mobile block.

79. The apparatus according to claim 78, wherein it comprises a first and a second guide rod.

80. The apparatus according to claim 79, wherein the drive shaft extends between the guide rods.

81. The apparatus according to claim 78, wherein it comprises freely expanding means for connecting the guide means to the base.

82. The apparatus according to claim 81, wherein the freely expanding means for connecting the guide means to the base comprise interposed means located between the guide means and the base.

83. The apparatus according to claim 81, wherein the freely expanding means for connecting the guide means to the base comprise means for fastening them to the base and means for fastening them to the guide means, the means for fastening them to the guide means being connected to the means for fastening them to the base in such a way as to allow free movement in the direction of extension of the guide means.

84. The apparatus according to claim 83, wherein it comprises a set of fastening blocks that are aligned with each other and distributed lengthways, and connected to the main body in such a way as to be able to move lengthways along the main body.

85. The apparatus according to claim 69, wherein it comprises a graduated measuring rod.

86. The apparatus according to claim 85, wherein the graduated measuring rod is raised with respect to the guide means.

87. An apparatus for calibrating measuring instruments, such as bore gauges and the like, and comprising means for supporting the apparatus and calibrating means having contact means for the respective measuring ends of the instruments to be calibrated, and consisting, for each end of the measuring instrument to be calibrated, of a first and a second contact surface; wherein it comprises at least one adapter element on at least one of the contact surfaces of the calibrating apparatus, said adapter element comprising means for engaging a corresponding portion of the respective end of the measuring instrument, wherein it comprises an adapter element fastened to a fixed supporting block and in that the contact surface at the end of the measuring instrument is fastened to a respective fixed supporting block that is separate from the block that supports the adapter element.
